(19) United States
(12) Patent Application Publication
(10) Pub. No.: US 2025/0255270 A1
(43) Pub. Date: Aug. 14, 2025

(54) Dog Cushioned Outside Door Protector Device

(71) Applicant: Eric Hendrich, Noblesville, IN (US)

(72) Inventor: Eric Hendrich, Noblesville, IN (US)

(21) Appl. No.: 18/819,187

(22) Filed: Aug. 29, 2024

Related U.S. Application Data
(60) Provisional application No. 63/551,092, filed on Feb. 8, 2024.

(51) Int. Cl. A01K 1/035

(52) U.S. Cl. CPC A01K 1/035

(57) ABSTRACT

A cushion and protector device is disclosed, which is a cushioned pad for dogs to put their legs on when looking out a window. The cushion and protector device comprises a body component that is configured in a rectangular shape that fits over a vehicle door. The body component comprises a magnetic section that sticks to the exterior of the vehicle door and a padded or cushioned flap section that sits over the window ledge. The padded or cushioned flap section utilizes hook and loop fasteners to attach to the inside of the vehicle door. Thus, the padded flap section offers a soft, comfortable resting place for dogs' paws, and the magnetic section prevents a dog's nails from scratching the vehicle's exterior. Additionally, the device is available in different colors and designs to accommodate all aesthetic preferences.

### CROSS-REFERENCE TO RELATED APPLICATION

The present application claims priority to, and the benefit of, U.S. Provisional Application No. 63/551,092, which was filed on Feb. 8, 2024, and is incorporated herein by reference in its entirety.

### FIELD OF THE INVENTION

The present invention relates generally to the field of cushion and protector devices. More specifically, the present invention relates to a cushioned pad for dogs and other animals to rest their legs and paws on while looking out a vehicle window. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in cushion and protector devices. Generally, when traveling with dogs, the dog may enjoy putting their head out the window with their paws and legs resting against the top of the door. However, dogs can develop sore legs from having to place their paws and legs on the door ledge. Further, scratches to the vehicle's exterior paint can occur if the dog's nails end up contacting the exterior.

Many pet owners enjoy taking their pets for rides in a car or other vehicle. As a result, people may often be seen driving a vehicle and having dogs, cats, or other pets within the vehicle. While some pets are transported within vehicles using enclosures or transporters, pet owners often enjoy having the pet at large within the vehicle interior.

Unfortunately, as much as pet owners and dogs or other pets seem to enjoy this activity, certain problem areas arise for both the pets and their owners in connection with this practice. For example, the typical interior door shelf of a vehicle beneath the window is formed in a slope or rounded and downwardly curved configuration. This type of surface does not usually prove to be a good area for the pet to stand or partially support itself as the vehicle moves and various momentum forces are applied to the dog. In addition, the typical door panel interior of a vehicle is upholstered to obtain certain aesthetic and comfort benefit for the vehicle users. Thus, attempts by dogs or other pets to maintain their paw positions upon the door panel shelf may result in scratching or other damage to the surface of the upholstered interior panel.

Accordingly, there is a demand for an improved cushion and protector device that provides a cushion for dogs to rest their legs and paws on while looking out a window. More particularly, there is a demand for a cushion and protector device that prevents dogs from getting uncomfortable and suffering from sore legs, when riding in a vehicle.

Therefore, there exists a long-felt need in the art for a cushion and protector device that provides vehicle owners with a cushioned pad for dogs to rest their legs and paws on while looking out a window. There is also a long-felt need in the art for a cushion and protector device that utilizes a heavy duty magnet to attach the device to a door, as well as a padded flap that sits over the open window ledge. Further, there is a long-felt need in the art for a cushion and protector device that allows dogs to comfortably rest on the cushioned pad rather than the window and vehicle. Moreover, there is a long-felt need in the art for a device that prevents paint from being scratched on the vehicle exterior due to dog nails. Further, there is a long-felt need in the art for a cushion and protector device that prevents dogs from getting uncomfortable and suffering from sore legs after riding in a vehicle. Finally, there is a long-felt need in the art for a cushion and protector device that is available in different colors and designs.

The subject matter disclosed and claimed herein, in one embodiment thereof, comprises a cushion and protector device. The device is a cushioned pad for dogs to put their legs on when looking out a window. The cushion and protector device comprises a body component that is configured in a rectangular shape that fits over a vehicle door. The body component comprises a magnetic section that sticks to the exterior of the vehicle door and a padded or cushioned flap section that sits over the window ledge. The padded or cushioned flap section utilizes hook and loop fasteners to attach to the inside of the vehicle door. Thus, the padded flap section offers a soft, comfortable resting place for dogs' paws, and the magnetic section prevents a dog's nails from scratching the vehicle's exterior. Additionally, the device is available in different colors and designs to accommodate all aesthetic preferences.

In this manner, the cushion and protector device of the present invention accomplishes all of the foregoing objectives and provides users with a device that protects a vehicle and prevents dogs from getting sore legs when riding in a vehicle. The device provides a cushioned pad. The device is available in different colors and designs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cushion and protector device. The device is a cushioned pad for dogs to put their legs on when looking out a window. The cushion and protector device comprises a body component that is configured in a rectangular shape that fits over a vehicle door. The body component comprises a magnetic section that sticks to the exterior of the vehicle door and a padded or cushioned flap section that sits over the window ledge and extends down to attach to the inside of the vehicle door. Thus, the padded flap section offers a soft, comfortable resting place for dogs' paws, and the magnetic section prevents a dog's nails from scratching the vehicle's exterior.

In one embodiment, the cushion and protector device is designed to be used with a pet, such as a dog, a cat, a pig, a bearded dragon, a hamster, a guinea pig, etc., or any other suitable animal as is known in the art. Further, the cushion and protector device is utilized within a vehicle, such that animals can comfortably ride in said vehicle. Typical vehicles include a vehicle interior with a vehicle dashboard, front and passenger seats, and front and passenger doors. Further, front and passenger doors each support a side window and further include a door shelf and window ledge. Accordingly, the vehicle interior, including the door shelves, window ledges, dashboard, front and passenger seats, side windows, and doors are fabricated in accordance with conventional fabrication techniques.

In one embodiment, the cushion and protector device is positioned on the window ledge and door shelf, during use. The cushion and protector device comprises a body component configured in a rectangular shape that fits over a vehicle door. The body component can be any suitable shape as is known in the art and can be sized and shaped to fit any desired vehicle, depending on the needs and/or wants of a user. Further, the body component comprises a magnetic section and a padded or cushioned flap section. The padded or cushioned flap section is sized and shaped to cover the window ledge and door shelf of the vehicle. The padded or cushioned flap section comprises a support surface extending inwardly from the side window and is sized and shaped to accommodate at least the front legs of the animal, and depending on how big the animal is, can accommodate the entire animal. Typically, the support surface is covered by a surface cover. For example, the support surface may be covered by a cushioned or padded material, synthetic turf, carpet, very close nap fabric, sprayed adhesive or painted on gripping material, such as plastic or rubberized paint, artificial turf, non-slip material, etc., or simply formed as desired in the fabrication process. In use, a typical dog having rear paws standing upon the pet owner or on the vehicle seat in an upright position would be supported by resting its front paws upon the surface cover of the support surface.

Further, as the front paws of the dog do not come in contact with the door shelf but instead contact solely upon the surface cover of the support surface, a vehicle's upholstery is protected. Thus, the upholstery material typically used on the door shelf is protected from damage due to the front paws and the scratching action of the dogs' nails. It will be further apparent to those skilled in the art, that the support surface provides a more desirable surface for supporting the front paws of a dog or other animal, in that the support surface extends substantially horizontally into the vehicle interior. This provides a much more readily gripped and much more supporting surface for the front paws of a dog. Further, while dogs and other animals may rest their front paws on the support surface, other animals may utilize the device in different postures without departing from the spirit and scope of the present invention. For example, extremely small animals may find it desirable to rest entirely upon the support surface without resorting to the stand-up position.

In one embodiment, the surface cover can be partially peeled back from the support surface to reveal an attachment coating adhesive. Thus, the surface cover is secured to the support surface by an adhesive. Typically, the adhesive is a reusable adhesive of the type used in contact cement or the like to facilitate removing and replacing of the surface cover, as the surface cover becomes soiled or worn. Alternatively, the adhesive may be a permanent attachment, anticipating that the user will simply replace the entire device when such wear or soiling of the surface cover occurs. In another embodiment, the surface cover is secured to the support surface via a pair of attachment pad hook and loop strips, which are secured directly to the support surface and cooperate with a pair of attachment pad hook and loop strips positioned on the underside surface cover, to facilitate removable attachment of the surface cover.

It should be noted that the present invention cushion and protector device is not limited to side windows but rather may be used in other environments, such as the rear window of certain pickup trucks or the panel windows and bed areas of pickup trucks, panel trucks, camper truck shells or pickup truck beds without departing from the present invention.

In one embodiment, the padded flap section (i.e., with a soft neoprene pad) can lie relatively flat over (i.e., cover or overlay) the door shelf and window ledge, with the exterior surface being exposed to the pet. The padded flap section can be manufactured in various dimensions to accommodate various applications, door sizes, etc., including some with adjustable and/or extendable dimensions (i.e., a foldable flap to provide more or less coverage). In various embodiments, the padded flap section can be a one-piece, two-piece, foldable sections, etc., of neoprene and plastic that can be used when taking pets for a ride in a vehicle, so that the pet can enjoy the window safely without damaging the vehicle door.

In one embodiment, the cushion and protector device protects a vehicle door from dirt, drool, soil, debris, scratches, scuffs, wear, damage, etc., from the pet, including, for example, from the pet's feet, paws, mouth, etc. This may be especially important if the pet places its head and/or feet directly on the vehicle door and/or window.

In one embodiment, the padded flap section extends across the window ledge and door shelf and extends down the vehicle door. Thus, a more flexible (i.e., neoprene) section of the padded flap section can hang down over the inside of the vehicle door, protecting the door (trim) and handle/armrest from pet dirt, drool, soil, debris, scratches, scuffs, wear, damage, etc. The inside/flexible section can also provide for pet traction to minimize/avoid slipping or falling when the vehicle accelerates, stops, and/or turns. Further, the flexible section is secured to the vehicle door via hook and loop fasteners or any other suitable fasteners as is known in the art, to releasably secure the device to the interior of the vehicle door.

In one embodiment, the body component comprises a magnetic section which is positioned over the window ledge and extends down over the exterior of the vehicle door several inches. The magnetic section is typically neoprene, plastic, or any other suitable durable material as is known in the art to prevent scratches on a vehicle door from a pet's paws/nails. The interior of the magnetic section typically comprises magnets or other fasteners to releasably secure the magnetic section to a vehicle door. When installed, the device would bend along its axis, such that the magnetic section hangs down the exterior of the vehicle door and the flexible section hangs down the interior of the vehicle door.

The cushion and protector device can be made from any suitable materials that provide suitable sections for securing to the vehicle door and for providing protection and cushioning features. Materials may be suitable for various pets and applications. Various sizes can be utilized based on the application, including, for example, based on the size of the vehicle door, the area to be protected, door panel shape, etc. Material durometer and thicknesses for each section can also be selected to be suitable for the purpose of the application. Thicknesses can also vary or taper to provide easier installation, more protection, etc., in certain areas. Multiple sections can be joined via any suitable process, including, for example, stitching, gluing, molding (including co-molding), heat-staking, etc.

In one embodiment, material variations/properties can also include color (i.e., to match vehicle interior), patterns, designs, words (i.e., imprinted with pet name), anti-microbial properties, hypoallergenic, washable, scented, etc., and can be functional and/or decorative.

Some embodiments include a universal cushion and protector device that can be constructed to allow the user to customize the size and/or shape of the cushion and protector device to meet the vehicle and/or user needs. For example, in one embodiment, a large or oversized cushion and protector device can be provided for the cutting/trimming of one or more sections by the user. This embodiment can accommodate various door inside configurations and door outside trim configurations. In some embodiments, cut-outs can be made to accommodate unique vehicle features (i.e., door lock post on top of door trim, etc.).

Some embodiments can include a biased form for easy stowage when not in use. For example, multiple sections can be biased to lay flat against each other when not in use but have a flexible joint that bends easily during installation over the window ledge of the vehicle door.

In yet another embodiment, the cushion and protector device comprises a plurality of indicia.

In yet another embodiment, a method of protecting a vehicle door and cushioning an animal when riding in a vehicle is disclosed. The method includes the steps of providing a cushion and protector device comprising a body component with a magnetic section and padded flap section. The method also comprises securing the magnetic section to an exterior of the vehicle's door to prevent scratches. Further, the method comprises positioning the padded flap section on a window ledge of the vehicle. The method also comprises securing the padded flap section via hook and loop fasteners attached to the interior of the vehicle door. Finally, the method comprises allowing a dog to sit on the padded flap section while riding in a vehicle and protecting the vehicle door from scratches via the magnetic section.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cushion and protector device of the present invention showing the device in use in accordance with the disclosed architecture;

FIG. 2 illustrates a perspective view of one embodiment of the cushion and protector device of the present invention showing the magnetic section of the device applied to a vehicle door in accordance with the disclosed architecture;

FIG. 3 illustrates a perspective view of one embodiment of the cushion and protector device of the present invention showing the padded flap section of the device applied to a window ledge in accordance with the disclosed architecture;

FIG. 4 illustrates a perspective view of one embodiment of the cushion and protector device of the present invention showing the hook and loop fasteners which attached the device to a vehicle door in accordance with the disclosed architecture;

FIG. 5 illustrates a perspective view of one embodiment of the cushion and protector device of the present invention showing the device applied to a vehicle door in accordance with the disclosed architecture; and

FIG. 6 illustrates a flowchart showing the method of protecting a vehicle door and cushioning an animal when riding in a vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a cushion and protector device that provides vehicle owners with a cushioned pad for dogs to rest their legs and paws on while looking out a window. There is also a long-felt need in the art for a cushion and protector device that utilizes a heavy duty magnet to attach the device to a door, as well as a padded flap that sits over the open window ledge. Further, there is a long-felt need in the art for a cushion and protector device that allows dogs to comfortably rest on the cushioned pad rather than the window and vehicle. Moreover, there is a long-felt need in the art for a device that prevents paint from being scratched on the vehicle exterior due to dog nails. Further, there is a long-felt need in the art for a cushion and protector device that prevents dogs from getting uncomfortable and suffering from sore legs after riding in a vehicle. Finally, there is a long-felt need in the art for a cushion and protector device that is available in different colors and designs.

The present invention, in one exemplary embodiment, is a novel cushion and protector device. The cushion and protector device comprises a body component that is configured in a rectangular shape that fits over a vehicle door. The body component comprises a magnetic section that sticks to the exterior of the vehicle door and a padded or cushioned flap section that sits over the window ledge. The padded or cushioned flap section utilizes hook and loop fasteners to attach to the inside of the vehicle door. Thus, the padded flap section offers a soft, comfortable resting place for dogs' paws, and the magnetic section prevents a dog's nails from scratching the vehicle's exterior. The present invention also includes a novel method of protecting a vehicle door and cushioning an animal when riding in a vehicle. The method includes the steps of providing a cushion and protector device comprising a body component with a magnetic section and padded flap section. The method also comprises securing the magnetic section to an exterior of the vehicle's door to prevent scratches. Further, the method comprises positioning the padded flap section on a window ledge of the vehicle. The method also comprises securing the padded flap section via hook and loop fasteners attached to the interior of the vehicle door. Finally, the method comprises allowing a dog to sit on the padded flap section while riding in a vehicle and protecting the vehicle door from scratches via the magnetic section.

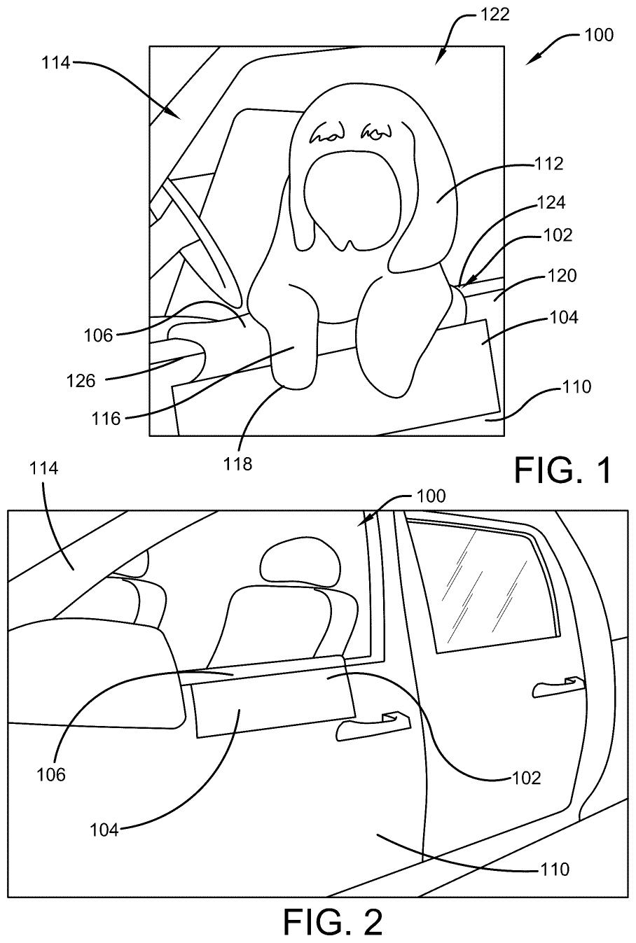

Referring initially to the drawings, FIG. 1 illustrates a perspective view of one embodiment of the cushion and protector device 100 of the present invention. In the present embodiment, the cushion and protector device 100 is an improved cushion and protector device 100 that provides a user with a cushioned pad for dogs 112 while riding in a vehicle 114. Specifically, the cushion and protector device 100 comprises a body component 102 that is configured in a rectangular shape that fits over a vehicle door 110. The body component 102 comprises a magnetic section 104 and a padded or cushioned flap section 106 secured via hook and loop fasteners 108 to a vehicle door 110. Thus, the padded flap section 106 offers a soft, comfortable resting place for dogs' paws 116, and the magnetic section 104 prevents a dog's nails 118 from scratching the vehicle's exterior 120.

Generally, the cushion and protector device 100 is designed to be used with a pet 112, such as a dog, a cat, a pig, a bearded dragon, a hamster, a guinea pig, etc., or any other suitable animal as is known in the art. Further, the cushion and protector device 100 is utilized within a vehicle 114, such that animals 112 can comfortably ride in said vehicle 114. Typical vehicles 114 include a vehicle interior with a vehicle dashboard, front and passenger seats, and front and passenger doors 110. Further, front and passenger doors 110 each support a side window 122 and further include a door shelf 124 and window ledge 126. Accordingly, the vehicle interior, including the door shelves 124, window ledges 126, dashboard, front and passenger seats, side windows 122, and doors 110 are fabricated in accordance with conventional fabrication techniques.

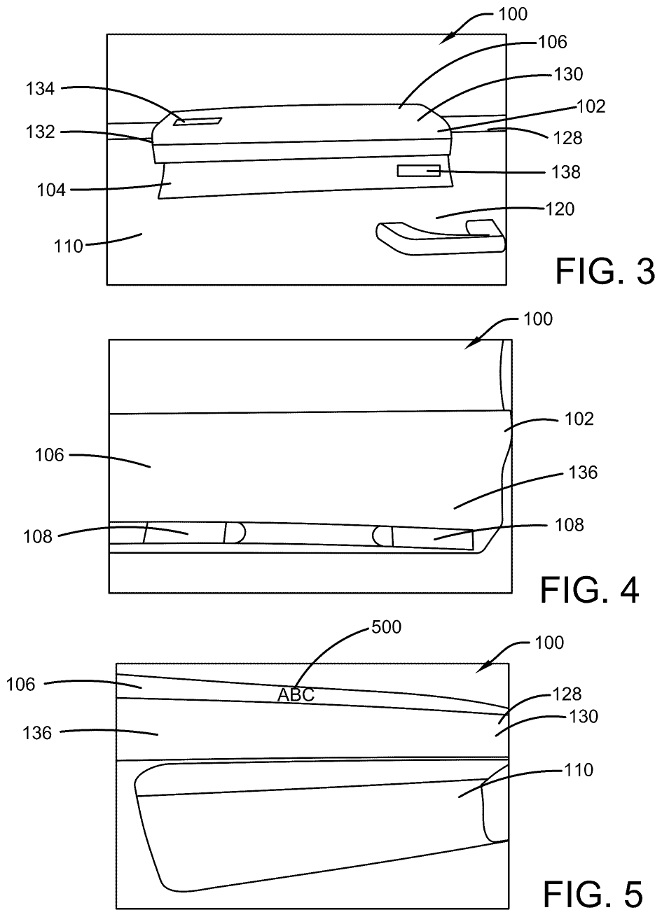

As shown in FIGS. 2-3, the cushion and protector device 100 is positioned on the window ledge 126 and door shelf 124, during use. The cushion and protector device 100 comprises a body component 102 configured in a rectangular shape that fits over a vehicle door 110. The body component 102 can be any suitable shape as is known in the art and can be sized and shaped to fit any desired vehicle 114, depending on the needs and/or wants of a user. Further, the body component 102 comprises a magnetic section 104 and a padded or cushioned flap section 106. The padded or cushioned flap section 106 is sized and shaped to cover the window ledge 126 and door shelf 124 of the vehicle 114. The padded or cushioned flap section 106 comprises a support surface 128 extending inwardly from the side window 122 and sized and shaped to accommodate at least the front legs 116 of the animal 112, and depending on how big the animal is, can accommodate the entire animal. Typically, the support surface 128 is covered by a surface cover 130. For example, the support surface 128 may be covered by a cushioned or padded material, synthetic turf, carpet, very close nap fabric, sprayed adhesive or painted on gripping material, such as plastic or rubberized paint, artificial turf, non-slip material, etc., or simply formed as desired in the fabrication process. In use, a typical dog 112 having rear paws 116 standing upon the pet owner or on the vehicle seat in an upright position, would be supported by resting its front paws 116 upon the surface cover 130 of the support surface 128.

Further, as the front paws 116 of the dog 112 do not come in contact with the door shelf 124 but instead contact solely upon the surface cover 130 of the support surface 128, a vehicle's upholstery is protected. Thus, the upholstery material typically used on the door shelf 124 is protected from damage due to the front paws 116 and the scratching action of the dogs' nails. It will be further apparent to those skilled in the art, that the support surface 128 provides a more desirable surface for supporting the front paws 116 of a dog 112 or other animal, in that the support surface 128 extends substantially horizontally into the vehicle interior. This provides a much more readily gripped and much more supporting surface for the front paws 116 of a dog 112. Further, while dogs 112 and other animals may rest their front paws 116 on the support surface 128, other animals 112 may utilize the device 100 in different postures without departing from the spirit and scope of the present invention. For example, extremely small animals may find it desirable to rest entirely upon the support surface 128 without resorting to the stand-up position.

Additionally, the surface cover 130 can be partially peeled back from the support surface 128 to reveal an attachment coating adhesive 132. Thus, the surface cover 130 is secured to the support surface 128 by an adhesive 132. Typically, the adhesive 132 is a reusable adhesive of the type used in contact cement or the like to facilitate removing and replacing of the surface cover 130, as the surface cover 128 becomes soiled or worn. Alternatively, the adhesive 132 may be a permanent attachment, anticipating that the user will simply replace the entire device 100 when such wear or soiling of the surface cover 128 occurs. In another embodiment, the surface cover 128 is secured to the support surface 130 via a pair of attachment pad hook and loop strips 134, which are secured directly to the support surface 128 and cooperate with a pair of attachment pad hook and loop strips positioned on the underside surface cover 130, to facilitate removable attachment of the surface cover 130.

Furthermore, the cushion and protector device 100 protects a vehicle door 110 from dirt, drool, soil, debris, scratches, scuffs, wear, damage, etc., from the pet 112, including, for example, from the pet's feet, paws, mouth, etc. This may be especially important if the pet places its head and/or feet directly on the vehicle door 110 and/or window 122.

Additionally, the padded flap section 106 extends across the window ledge 126 and door shelf 124 and extends down the vehicle door 110. Thus, a more flexible (i.e., neoprene) section 136 of the padded flap section 106 can hang down over the inside of the vehicle door 110, protecting the door (trim) and handle/armrest from pet dirt, drool, soil, debris, scratches, scuffs, wear, damage, etc. The inside/flexible section 136 can also provide for pet traction to minimize/avoid slipping or falling when the vehicle accelerates, stops, and/or turns. Further, the flexible section 136 is secured to the vehicle door 110 via hook and loop fasteners 108 or any other suitable fasteners as is known in the art, to releasably secure the device 100 to the interior of the vehicle door 110.

Furthermore, the body component 102 comprises a magnetic section 104 which is positioned over the window ledge 126 and extends down over the exterior 120 of the vehicle door 110 several inches. The magnetic section 104 is typically neoprene, plastic, or any other suitable durable material as is known in the art to prevent scratches on a vehicle door 110 from a pet's paws/nails 116. The interior of the magnetic section 104 typically comprises magnets 138 or other fasteners to releasably secure the magnetic section 104 to a vehicle door 110. When installed, the device 100 would bend along its axis, such that the magnetic section 104 hangs down the exterior 120 of the vehicle door 110 and the flexible section 136 hangs down the interior of the vehicle door 110.

As shown in FIGS. 4-5, it should be noted that the present invention cushion and protector device 100 is not limited to side windows 122 but rather may be used in other environments, such as the rear window of certain pickup trucks or the panel windows and bed areas of pickup trucks, panel trucks, camper truck shells or pickup truck beds without departing from the present invention.

Typically, the padded flap section 106 (i.e., with a soft neoprene pad) can lie relatively flat over (i.e., cover or overlay) the door shelf 124 and window ledge 126, with the exterior surface being exposed to the pet 112. The padded flap section 106 can be manufactured in various dimensions to accommodate various applications, door sizes, etc., including some with adjustable and/or extendable dimensions (i.e., a foldable flap to provide more or less coverage). In various embodiments, the padded flap section 106 can be a one-piece, two-piece, foldable sections, etc., of neoprene and plastic that can be used when taking pets 112 for a ride in a vehicle 114, so that the pet 112 can enjoy the window 122 safely without damaging the vehicle door 110.

Further, the cushion and protector device 100 can be made from any suitable materials that provide suitable sections for securing to the vehicle door 110 and for providing protection and cushioning features. Materials may be suitable for various pets and applications. Vary sizes can be utilized based on the application, including, for example, based on the size of the vehicle door 110, the area to be protected, door panel shape, etc. Material durometer and thicknesses for each section can also be selected to be suitable for the purpose of the application. Thicknesses can also vary or taper to provide easier installation, more protection, etc., in certain areas. Multiple sections can be joined via any suitable process, including, for example, stitching, gluing, molding (including co-molding), heat-staking, etc.

Additionally, material variations/properties can also include color (i.e., to match vehicle interior), patterns, designs, words (i.e., imprinted with pet name), anti-microbial properties, hypoallergenic, washable, scented, etc., and can be functional and/or decorative.

Some embodiments include a universal cushion and protector device 100 that can be constructed to allow the user to customize the size and/or shape of the cushion and protector device 100 to meet the vehicle 114 and/or user needs. For example, in one embodiment, a large or oversized cushion and protector device 100 can be provided for the cutting/trimming of one or more sections by the user. This embodiment can accommodate various door inside configurations and door outside trim configurations. In some embodiments, cut-outs can be made to accommodate unique vehicle features (i.e., door lock post on top of door trim, etc.).

Some embodiments can include a biased form for easy stowage when not in use. For example, multiple sections can be biased to lay flat against each other when not in use but have a flexible joint that bends easily during installation over the window ledge 126 of the vehicle door 110.

In yet another embodiment, the cushion and protector device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be pet, vehicle, or brand related.

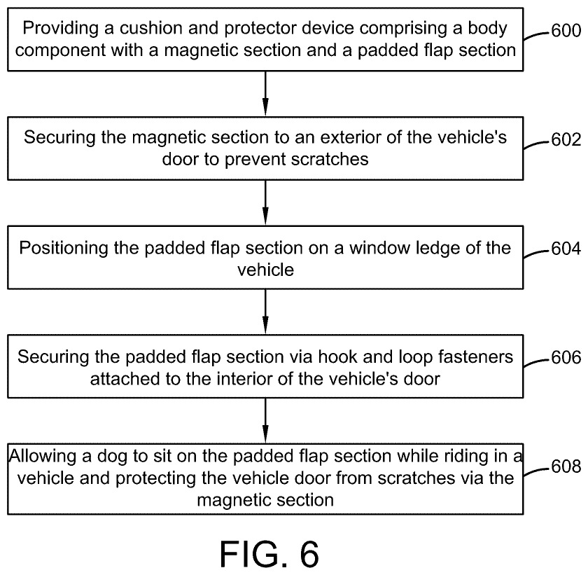

FIG. 6 illustrates a flowchart of the method of protecting a vehicle door and cushioning an animal when riding in a vehicle. The method includes the steps of at 600, providing a cushion and protector device comprising a body component with a magnetic section and padded flap section. The method also comprises at 602, securing the magnetic section to an exterior of the vehicle's door to prevent scratches. Further, the method comprises at 604, positioning the padded flap section on a window ledge of the vehicle. The method also comprises at 606, securing the padded flap section via hook and loop fasteners attached to the interior of the vehicle door. Finally, the method comprises at 608, allowing a dog to sit on the padded flap section while riding in a vehicle and protecting the vehicle door from scratches via the magnetic section.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cushion and protector device”, “cushion device”, “protector device”, and “device” are interchangeable and refer to the cushion and protector device 100 of the present invention.

Notwithstanding the foregoing, the cushion and protector device 100 of the present invention can be of any suitable size and configuration as is known in the art without affecting the overall concept of the invention, provided that it accomplishes the above-stated objectives. One of ordinary skill in the art will appreciate that the cushion and protector device 100 as shown in FIGS. 1-6 is for illustrative purposes only, and that many other sizes and shapes of the cushion and protector device 100 are well within the scope of the present disclosure. Although the dimensions of the cushion and protector device 100 are important design parameters for user convenience, the cushion and protector device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cushion and protector device that provides a user with a cushioned pad for dogs while riding in a vehicle, the cushion and protector device comprising:
a body component;
wherein the body component is configured in a rectangular shape that fits over a vehicle door;
wherein the body component comprises a magnetic section and a padded flap section secured to a vehicle door; and
wherein the padded flap section offers a soft, comfortable resting place for dogs' paws, and the magnetic section prevents a dog's nails from scratching a vehicle's exterior.

2. The cushion and protector device of claim 1, wherein the cushion and protector device is used with a pet, such as a dog or cat.

3. The cushion and protector device of claim 2, wherein the padded flap section is positioned to cover a window ledge and a door shelf of a vehicle.

4. The cushion and protector device of claim 3, wherein the padded flap section comprises a support surface extending inwardly from a side window and sized and shaped to accommodate at least front legs of the dog.

5. The cushion and protector device of claim 4, wherein the support surface is covered by a surface cover comprised of a cushioned material.

6. The cushion and protector device of claim 5, wherein the surface cover is secured to the support surface by an adhesive.

7. The cushion and protector device of claim 6, wherein the padded flap section extends across the window ledge and door shelf and a flexible section extends down an interior of a vehicle door to protect the vehicle door from scratches and dirt.

8. The cushion and protector device of claim 7, wherein the flexible section is secured to the interior of the vehicle door via hook and loop fasteners.

9. The cushion and protector device of claim 8, wherein the magnetic section is positioned over a window ledge and extends down over an exterior of the vehicle door.

10. The cushion and protector device of claim 9, wherein interior of the magnetic section comprises magnets to releasably secure the magnetic section to a vehicle door for protection.

11. The cushion and protector device of claim 10, wherein the body component can be manufactured in various colors and designs for aesthetic purposes.

12. The cushion and protector device of claim 11, wherein the body component can be manufactured with anti-microbial or hypoallergenic coatings.

13. A cushion and protector device that provides a user with a cushioned pad for dogs while riding in a vehicle, the cushion and protector device comprising:
a body component;
wherein the body component is configured in a rectangular shape that fits over a vehicle door;
wherein the body component comprises a magnetic section and a padded flap section secured to a vehicle door;
wherein the padded flap section offers a soft, comfortable resting place for dogs' paws and is positioned to cover a window ledge and a door shelf of a vehicle;
wherein the padded flap section comprises a support surface extending inwardly from a side window and sized and shaped to accommodate at least a front legs of the dog;
wherein the support surface is covered by a surface cover comprised of a cushioned material;
wherein the padded flap section extends across the window ledge and door shelf and a flexible section extends down an interior of a vehicle door to protect the vehicle door from scratches and dirt;
wherein the magnetic section prevents a dog's nails from scratching a vehicle's exterior and is positioned over a window ledge and extends down over an exterior of the vehicle door; and
further wherein interior of the magnetic section comprises magnets to releasably secure the magnetic section to a vehicle door for protection.

14. The cushion and protector device of claim 13, wherein the body component can be manufactured in various colors and designs for aesthetic purposes.

15. The cushion and protector device of claim 13, wherein the body component can be manufactured with anti-microbial or hypoallergenic coatings.

16. The cushion and protector device of claim 13, wherein the body component is biased to lay flat when not in use, but has flexible joints that bend easily during installation over the window ledge of the vehicle door.

17. The cushion and protector device of claim 13 further comprising a plurality of indicia.

18. The cushion and protector device of claim 13, wherein the surface cover is secured to the support surface by an adhesive.

19. The cushion and protector device of claim 13, wherein the flexible section is secured to the interior of the vehicle door via hook and loop fasteners.

20. A method of protecting a vehicle door and cushioning an animal when riding in a vehicle, the method comprising the following steps:
providing a cushion and protector device comprising a body component with a magnetic section and padded flap section;
securing the magnetic section to an exterior of the vehicle's door to prevent scratches; positioning the padded flap section on a window ledge of the vehicle;
securing the padded flap section via hook and loop fasteners attached to the interior of the vehicle door; and
allowing a dog to sit on the padded flap section while riding in a vehicle and protecting the vehicle door from scratches via the magnetic section.
